(19) United States
(12) Patent Application Publication
(10) Pub. No.: US 2014/0190847 A1
(43) Pub. Date: Jul. 10, 2014

(54) Washing Capsule For Providing A Washing Composition To A Machine

(71) Applicants: Lucia Krubasik, Ludwigshafen (DE); Judith Preuschen, Ludwigshafen (DE); Pavlinka Roy, Ludwigshafen (DE)

(72) Inventors: Lucia Krubasik, Ludwigshafen (DE); Judith Preuschen, Ludwigshafen (DE); Pavlinka Roy, Ludwigshafen (DE)

(73) Assignee: RECKITT BENCKISER N.V., Hoofddorp (NE)

(21) Appl. No.: 13/982,619

(22) PCT Filed: Jan. 30, 2012
(86) PCT No.: PCT/GB2012/050185

§ 371 Date: Oct. 25, 2013

(30) Foreign Application Priority Data
Jan. 31, 2011 (GB) 1101595.5

(51) Int. Cl. C11D 17/04; B65D 81/32

(52) U.S. Cl. CPC C11D 17/04; B65D 81/3277
USPC 206/219; 53/445

(57) ABSTRACT

The present invention provides a washing capsule for providing a washing composition to a machine, the capsule comprising a solid tablet of a first washing composition and at least one rigid water-soluble shell fixed directly to the solid tablet to define a cavity between the shell and the tablet, the cavity containing a liquid or gel of a second washing composition. A method of producing the capsule is also provided.

The present invention relates to a washing capsule for providing a washing composition to a machine. The machine may either be a washing machine or a dishwasher.

A recent development in the field of dishwashing tablets has been the Quantum® tablet sold by Reckitt Benckiser. This is described, for example, in WO 01/36290.

This tablet has a rigid water-soluble housing which is formed by injection moulding and which has one or more internal walls to define separate cavities within the tablet. These cavities are filled with different washing compositions in solid or gel form.

The product has met with significant success as the rigid water-soluble housing allows the product to be provided to the consumer without an individual wrapper thereby facilitating handling and reducing waste.

As the housing is injection moulded, it is necessary, in order to achieve a balanced mould, for the thicknesses of the external wall and internal partitions to be of comparable thickness. Because of this, the internal partitions are thicker than they need to be to fulfil their function in the machine. This is generally wasteful, as, although some additives are provided in the material forming the partitions, these are in significantly lower concentrations than the active ingredients in the cavities. As such, they contribute far less to the washing process.

According to the present invention, there is provided a washing capsule for providing a washing composition to a machine, the capsule comprising a solid tablet of a first washing composition and at least one rigid water-soluble shell fixed directly to the solid tablet to define a cavity between the shell and the tablet, the cavity containing a liquid or gel of a second washing composition.

Fixing a water-soluble shell directly to the solid tablet removes the need for an injection moulded partition between the two compositions.

If the second composition is one which will not dissolve or react with the first composition, then second washing composition may be in direct contact with the first washing composition.

Alternatively, the part of the solid table which faces the cavity may be coated with a water-soluble barrier. This allows greater freedom in the washing compositions with which it can be used. As this barrier is a coating, rather than an injection moulded partition, it can be significantly thinner than an injection moulded wall (preferably less than 0.2 mm thick, and more preferably less than 0.1 mm thick). The barrier may be sprayed on or formed in a dipping process.

A further issue with regard to an injection moulded shell arises when three or more different compositions are to be dispensed. The three or more compositions require two or more internal partition walls. Not only must these walls be approximately the same thickness as the outer wall, they must also be approximately the same thickness as one another. It is generally desirable to configure a capsule with multiple compositions so that these can be dispensed at different times during the wash cycle. As the partition walls have to be of generally uniform thickness, this is difficult to achieve with such an injection moulded structure.

Preferably, the capsule comprises a second rigid water-soluble shell fixed directly to the solid tablet to define a cavity between the second shell and the tablet, the cavity containing a liquid or gel of the second or a third washing composition.

The purpose of the second shell could simply be to provide more of the second washing composition. However, preferably, it can be more usefully employed to contain a third washing composition. As the two shells are both fixed directly to the solid tablet, they can be manufactured independently of one another and can therefore be made to be different thicknesses and/or of different compositions giving much greater freedom for the timing of the dispensing of the various compositions.

While, in theory, there may be more than two rigid water-soluble shells directly fixed to the solid tablet, this will require a more complex shape of solid tablet. Preferably, the two water-soluble shells are respectively fixed on opposite sides of the solid tablet to provide a generally “lozenge” shape capsule. Such a structure can be created with a simple shape of solid tablet and is easy to handle for a consumer. Also, it is able to dispense up to three different washing compositions which is generally enough for most dishwashing/washing machines.

One problem which generally arises with washing capsules is that the washing composition contains bleach which, in time, decomposes to produce oxygen. If this cannot escape, it causes swelling of the capsule. With the present invention, parts of the solid tablet are preferably exposed to the external environment to allow the gas to vent.

In the case where two shells are fixed to the solid tablet, there is, preferably, a gap of between 0.5 mm and 13.3 mm, and more preferably between 6 mm and 10 mm is provided between the shells to expose a portion of the tablet. This is a very simple way of producing the capsule which does not require a wrapper as the vast majority of the outer surface of the capsule is provided by the two shells, but the gap is readily able to prevent swelling.

The present invention also extends to a method of manufacturing a washing capsule for providing a washing composition to a machine, the method comprises filling a rigid water-soluble shell with a liquid or gel of the second washing composition, inserting a solid tablet of a first washing composition into the shell and fixing the shell to the tablet in order to form a closed liquid-containing cavity between the shell and the tablet.

The method preferably further comprises filling a second shell with the second or a third washing composition of a liquid or gel, inverting the solid tablet, with the first shell attached onto the filled second shell and fixing the inner periphery of the second shell to the outer periphery of the tablet to form a second liquid/gel containing cavity. This process is able to provide a lozenge-shaped capsule having three separate phases as described above.

The fixing may be done by a method, such as ultrasonic welding, but is preferably done using an adhesive, preferably a hot-melt adhesive.

An example of a capsule in accordance with the present invention will now be described with reference to the accompanying drawings, in which:

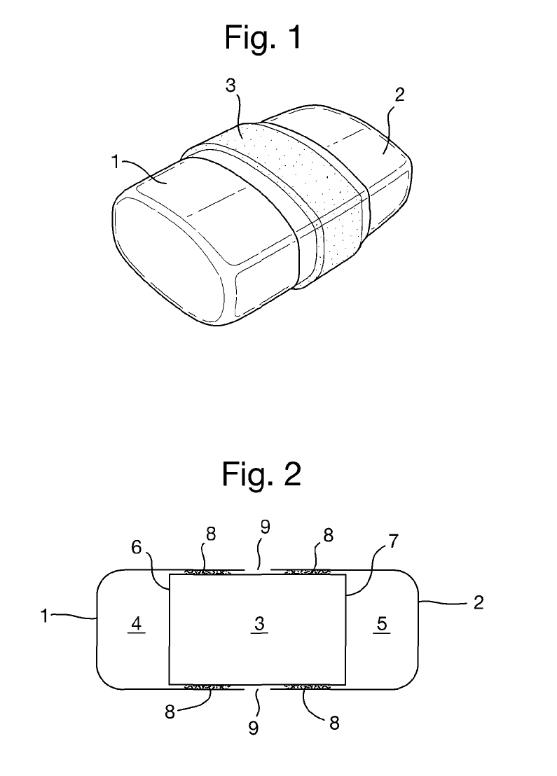

FIG. 1 is a perspective view of a capsule; and

FIG. 2 is a cross-section through the capsule.

As shown, the capsule comprises a pair of shells 1, 2 of rigid water-soluble material which are bonded to opposite ends of a solid tablet 3 of a first washing composition so as to form respective cavities 4, 5 which are filled with liquid/gel washing compositions which may either be the same or different.

The tablet 3 may be any known solid formulation for a dishwasher/washing machine composition. For example, it may be a compressed powder. It may be a single layer formulation, but may equally be a multiple layer formulation. Depending upon the nature of the liquid formulation of cavities 4 and 5, the end faces 6, 7 of the tablet 3 may be sprayed or otherwise coated with a layer of, for example, PVOH. The composition of such layers is well-known in the art (for example, WO 01/36290).

Shells 1, 2 may be any rigid water-soluble material, for example, PVOH or HPMC which may also be provided with additives. They are preferably injection moulded. For further details of the material, reference is made to WO 01/36290 which uses a similar rigid water-soluble material.

For ease of reference the term ‘liquid’ as used below applies equally to ‘gels’ of the invention.

The liquid in the capsule preferably comprises a surfactant, e.g., liquid mixed alkoxylate fatty alcohol non-ionic surfactant. The liquid may, for example, be a detergent, a rinse aid, a fabric softener, a stain remover, a water softener or other washing composition.

Nonionic surfactants are preferred for automatic dishwashing and some other hard surface cleaning operations as they are considered to be low foaming surfactants.

Suitable nonionic surfactants include alkoxylated non-ionic surfactants prepared by the reaction of a monohydroxy alkanol or alkylphenol with 6 to 20 carbon atoms. Preferably the surfactants have at least 8 moles particularly preferred at least 10 moles, and still more preferred 12 or more moles of alkylene oxide per mole of alcohol or alkylphenol. Preferred non-ionic surfactants are the non-ionics from a linear chain fatty alcohol with 10-18 carbon atoms and at least 8 moles, particularly preferred at least 10 and still more preferred at least 12 moles, of alkylene oxide per mole of alcohol. It is preferred that the nonionic surfactants comprise ethylene oxide in the alkylene oxide groups According to a preferred one embodiment of the invention, the non-ionic surfactants additionally may comprise propylene oxide units in the molecule in addition to ethylene oxide units.

The standard non-ionic surfactant structure is based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO). Surfactants may also comprise butylene oxide units (BO) as a result of butoxylation of the fatty alcohol. Preferably, this will be a mix with PO and EO units. The surfactant chain can be terminated with a butyl (Bu) moiety.

The length of the fatty alcohol and the degree of ethoxylation/propoxylation determines if the surfactant structure has a melting point below room temperature or in other words if is a liquid or a solid at room temperature. It is especially preferred that the nonionic surfactant used according to the invention is liquid or substantially liquid at room temperature (20° C.).

It is especially preferred that the mixed alkoxylate fatty alcohol nonionic surfactant comprises at least two EO, PO or BO groups and especially a mixture of EO and PO groups, preferably EO and PO groups only. It is most preferred that the mole ratio of the lower alkoxylate group to the higher alkoxylate group is at least 1.1:1, more preferably at least 1.5:1, and most preferably at least 1.8:1, such as at least 2:1 or even at least 3:1.

It is especially preferred that when a non-ionic surfactant is used in the liquid phase it comprises a liquid mixed alkoxylate fatty alcohol non-ionic surfactant comprising a greater number of moles of the lower alkoxylate group than of the higher alkoxylate group in the molecule, especially a greater number of EO groups than of PO groups.

The mixed alkoxylate fatty alcohol non-ionic surfactants used in the compositions of the invention may be prepared by the reaction of suitable monohydroxy alkanols or alkylphenols with 6 to 20 carbon atoms. Preferably the surfactants have at least 8 moles, particularly preferred at least 10 moles of alkylene oxide per mole of alcohol or alkylphenol. Particularly preferred liquid mixed alkoxylate fatty alcohol non-ionic surfactants are those from a linear chain fatty alcohol with 12-18 carbon atoms, preferably 12 to 15 carbon atoms and at least 10 moles, particularly preferred at least 12 moles of alkylene oxide per mole of alcohol.

An especially preferred mixed alkoxylate fatty alcohol nonionic surfactant according to the present invention comprises a C10-C18 Carbon chain, especially a C12-C16 carbon chain, between 3 to 5 moles of the higher alkoxylate group and between 6 to 10 moles the lower alkoxylate group. Especially preferred are mixed alkoxylate fatty alcohol nonionic surfactants having 4 or 5 moles of the higher alkoxylate group and 7 or 8 moles of the lower alkoxylate group. According to one aspect of the invention a mixed alkoxylate fatty alcohol nonionic surfactant having 4 or 5 PO moles and 7 or 8 EO moles is especially preferred, especially 4 PO moles and 8 EO moles. In an especially preferred embodiment the mixed alkoxylate fatty alcohol nonionic surfactant comprises a C10-C18 EO/PO surfactant, in particular a C12-15 EO/PO and most preferably a C12-15-(6-10)-EO-(3-5)PO surfactant such as a C12-15 8EO/4PO.

Surfactants of the above type which are ethoxylated monohydroxy alkanols or alkylphenols which additionally comprise poly-oxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant. When PO units are used they preferably constitute up to 25% by weight, preferably up to 20% by weight and still more preferably up to 15% by weight of the overall molecular weight of the non-ionic surfactant.

Suitable liquid mixed alkoxylate fatty alcohol non-ionic surfactants can be found in the class of reverse block copolymers of polyoxyethylene and poly-oxypropylene and block copolymers of polyoxyethylene and polyoxypropylene initiated with trimethylolpropane.

Suitable types can also be described by the formula:

R₁O[CH₂CH(CH₃)O]ₓ[CH₂CH₂O]_{y}[CH₂CH(OH)R₂]

where R1 represents a linear or branched chain aliphatic hydrocarbon group with 4-18 carbon atoms or mixtures thereof, R2 represents a linear or branched chain aliphatic hydrocarbon rest with 2-26 carbon atoms or mixtures thereof, x is a value between 0.5 and 1.5 and y is a value of at least 15.

Another group of suitable liquid mixed alkoxylate fatty alcohol non-ionic surfactants can be found in the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5 with the proviso that the molecule contains more of the lower alkoxylate than of the higher alkoxylate. When the value of x is >2 each R₃ in the formula above can be different. R₁ and R₂ are preferably linear or branched chain, saturated or unsaturated, aliphatic or aromatic hydrocarbon groups with 6-22 carbon atoms, where group with 8 to 18 carbon atoms are particularly preferred. For the group R₃═H, methyl or ethyl are particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃═H) or propylene oxide (R₃=methyl) units which can be used in every single order for instance (PO)(EO)(EO), (EO)(PO)(EO), (EO)(EO)(PO), (PO)(EO)(PO) and (PO)(PO)(EO). Only the mixed alkoxylates having comprising more of the lower alkoxylate than of the higher alkoxylate are suitable as the claimed mixed alkoxylate fatty alcohol nonionic surfactant. The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

Other suitable surfactants are disclosed in WO 95/01416, to the contents of which express reference is hereby made.

In a preferred embodiment of the present invention the mixed alkoxylate fatty alcohol non-ionic surfactants have the general formula;

R₁-[EO]ₙ-[PO]ₘ-[BO]ₚ-Bu_{q}

wherein:
R₁ is an alkyl group of between C₈ and C₂₀;
EO is ethylene oxide;
PO is propylene oxide;
BO is butylene oxide;
Bu is butylene
n and m are integers from 1 to 15;
p is an integer from 0 to 15; and
q is 0 or 1.

Examples of especially preferred mixed alkoxylate fatty alcohol non-ionic surfactants can be found in the Plurafac™, Lutensol™ and Pluronic™ ranges from BASF and the Genapol™ series from Clariant.

Other suitable surfactants are disclosed in WO 95/01416, to the contents of which express reference is hereby made.

The use of mixtures of any of the above nonionic surfactants is suitable in the context of the present invention.

Typically the liquid phase will comprise anionic or nonionic surfactant, when it is present, in an amount of from 10-100% wt based on the weight of this phase, preferably 50-100% wt. such as 75-95% wt.

Cationic surfactants which can be used in the compositions of the present invention, especially where a fabric conditioning effect is desired in a laundry application, contain amino or quaternary ammonium hydrophilic moieties which are positively charged when dissolved in water. Cationic surfactants among those useful herein are disclosed in the following documents, all incorporated by reference herein: M.C. Publishing Co., McCutcheon's Detergents and Emulsifiers, (North American edition 1979); Schwartz, et al., Surface Active Agents, Their Chemistry and Technology, New York: Interscience Publishers, 1949; U.S. Pat. No. 3,155,591, Hilfer, issued Nov. 3, 1964; U.S. Pat. No. 3,929,678, Laughlin, et al., issued Dec. 30, 1975; U.S. Pat. No. 3,959,461, Bailey, et al., issued May 25, 1976; and U.S. Pat. No. 4,387,090, Bolich, Jr., issued Jun. 7, 1983.

Among the quaternary ammonium-containing cationic surfactant materials useful herein are those of the general formula:

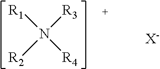

wherein R1-R4 are independently an aliphatic group of from about 1 to about 22 carbon atoms, or an aromatic, alkoxy, polyoxyalkylene, alkylamido, hydroxyalkyl, aryl or alkylaryl group having from about 12 to about 22 carbon atoms; and X is an anion selected from halogen, acetate, phosphate, nitrate and alkyl sulfate radicals. The aliphatic groups may contain, in addition to carbon and hydrogen atoms, ether linkages, and other groups such as amino groups.

Other quaternary ammonium salts useful herein have the formula:

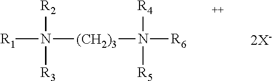

wherein R1 is an aliphatic group having from about 16 to about 22 carbon atoms, R2, R3, R4, R5, and R6 are selected from hydrogen and alkyl having from about 1 to about 4 carbon atoms, and X is an ion selected from halogen, acetate, phosphate, nitrate and alkyl sulfate radicals. Such quaternary ammonium salts include tallow propane diammonium dichloride. Preferred quaternary ammonium salts include dialkyldimethylammonium chlorides, wherein the alkyl groups have from about 12 to about 22 carbon atoms and are derived from long-chain fatty acids, such as hydrogenated tallow fatty acid (tallow fatty acids yield quaternary compounds wherein R1 and R2 have predominately from 16 to 18 carbon atoms). Examples of quaternary ammonium salts useful in the present invention include ditallowedimethyl ammonium chloride, ditallowedimethyl ammonium methyl sulfate, dihexadecyl dimethyl ammonium chloride, di(hydrogenated tallow) dimethyl ammonium chloride, dioctadecyl dimethyl ammonium chloride, dieicosyl dimethyl ammonium chloride, didocosyl dimethyl ammonium chloride, di(hydrogenated tallow) dimethyl ammonium acetate, dihexadecyl dimethyl ammonium chloride, dihexadecyl dimethyl ammonium acetate, ditallow dipropyl ammonium phosphate, ditallow dimethyl ammonium nitrate, di(coconutalkyl) dimethyl ammonium chloride, and stearyl dimethyl benzyl ammonium chloride. Ditallow dimethyl ammonium chloride, dicetyl dimethyl ammonium chloride, stearyl dimethyl benzyl ammonium chloride and cetyl trimethyl ammonium chloride are preferred quaternary ammonium salts useful herein. Di-(hydrogenated tallow) dimethyl ammonium chloride is a particularly preferred quaternary ammonium salt.

Salts of primary, secondary and tertiary fatty amines are also preferred cationic surfactant materials. The alkyl groups of such amines preferably have from about 12 to about 22 carbon atoms, and may be substituted or unsubstituted. Secondary and tertiary amines are preferred, tertiary amines are particularly preferred. Such amines, useful herein, include stearamido propyl dimethyl amine, diethyl amino ethyl stearamide, dimethyl stearamine, dimethyl soyamine, soyamine, myristyl amine, tridecyl amine, ethyl stearylamine, N-tallowpropane diamine, ethoxylated (5 moles E.O.) stearylamine, dihydroxy ethyl stearylamine, and arachidylbehenylamine. Suitable amine salts include the halogen, acetate, phosphate, nitrate, citrate, lactate and alkyl sulfate salts. Such salts include stearylamine hydrochloride, soyamine chloride, stearylamine formate, N-tallowpropane diamine dichloride and stearamidopropyl dimethylamine citrate. Cationic amine surfactants included among those useful in the present invention are disclosed in U.S. Pat. No. 4,275,055, Nachtigal, et al., issued Jun. 23, 1981, incorporated by reference herein.

If included in the compositions of the present invention, the cationic surfactant is preferably present at from 0.01% wt to percent to 10% wt, more preferably 0.1 to 5% wt such as 0.15 to 2% wt based on the weight of liquid phase.

Mixtures of anionic and nonionic surfactants, or, cationic and nonionic surfactants may also be used provided that such mixtures are stable.

The liquid phase may comprise one or more polymers, especially polymers not having a positive charge.

According to one embodiment of the present invention, it is preferred that the liquid phase comprises (statistical) copolymers of alkylene oxides. It especially preferred that the one or more polymer(s) comprise copolymers of ethylene oxide (EO) and propylene oxide (PO). Such polymers may be selected from the family of poly-glycols.

Especially preferred copolymers of alkylene oxides according to one embodiment of the invention are random, branched ethylene oxide/propylene oxide copolymers and especially those having a molecular weight of 500 to 50,000 g/mol, more preferably 2,000 to 40,000 g/mol and most preferably 4,000 to 30,000.

The structure of such copolymers is given below;

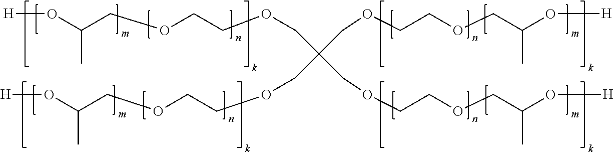

The ratio of EO units (n) to PO (m) is defined by the ratio n:m wherein N is in the range of from 1 to 100 and M is in the range of from 1 and 100. It is preferred that the ratio of n:m is in the range of from 50:1 to 1:50, more preferably in the range of from 20:1 to 1:10, such as of from 10:1 to 1:7, most especially 7:1 to 1:7. The value of K for each arm of the copolymer (k) may individually be in the range of from 1-5,000, more preferably in the range of from 10-2,500, most preferably of from 50-1,000.

Especially good results have been obtained with such alkylene oxide polymers having an n:m ratio in the range of from 10:1 to 1:1, and most especially in the range of from 6:1 to 1:1.

The viscosity of these polymers is typically in the range of from 75 to 50,000 mPas at 20° C., preferably 100 to 25,000.

The pH of the copolymers of alkylene oxides measured in 1 wt % water at 20° C. is in the range of from 5 to 12, most preferably in the range of from 6.5 to 7.5, for example 7. These copolymers are typically transparent liquids with a cloud point in the range of from 50° C. to 90° C.

These copolymers of alkylene oxides have a star-like shape and produce enhanced stability effects compared with standard solvents and surfactants. They are commercially available from Clariant, for example as Polyglykol P41/12000.

The polymer may be used as the liquid phase per se, that is, it may be used alone without additional ingredients therein. It may also be used in combination with other liquid ingredients in the liquid phase and/or in combination with minor amounts (typically less than 10% wt based on the weight of the liquid phase) of a dispersed solid phase (for example a bleach or bleach activator).

It is also possible for the liquid phase to comprise a combination of two or more of the above ingredients. Suitable examples of such mixtures include a mixture of an anionic and/or nonionic surfactant and a polymer of the aforementioned type, for example a combination of an anionic and/or nonionic surfactant and a copolymer of alkylene oxides as described above. In this case the weight ratio of the total amount of anionic/nonionic surfactant to the amount of polymer is preferably in the weight ratio of from 1:100 to 1:1, preferably 1:20 to 1:1, most preferably 1:10 to 1:1. The amount of the polymer present in the liquid phase is preferably in the range given below. The amount of surfactant can easily be calculated from the volume of the liquid phase and the ratio with the polymer. A mixture of a cationic surfactant and a polymer of the aforementioned type, for example a combination of a cationic surfactant and a copolymer of alkylene oxides as described above may also be used. In this case the weight ratio of the total amount of cationic surfactant to the amount of polymer is preferably as above for the anionic/nonionic surfactants. The amount of the polymer present in the liquid phase is preferably in the range given below. The amount of surfactant can easily be calculated from the volume of the liquid phase and the ratio with the polymer.

Typically the liquid phase will comprise the polymer in an amount of from 10-100% wt based on the weight of this phase, preferably 50-100% wt. such as 75-95% wt.

These polymers have been found to provide very good stability for the solid phase and the outer pouch. Indeed by using especially the EO:PO co-polymers having the m:n ratio above it has been found that it can be possible for the solid phase to be contained in a stable manner in the liquid phase without the need for the solid phase to itself have an outer coating or pouch. This has been found to be the case even when the solid phase comprises a bleach material. There is also the additional advantage that these copolymers of alkylene oxides provide antifoam benefits so that conventional antifoams do not always need to be additionally added to the detergent formulation. Also as these polymers are transparent they provide the consumer with an attractive product where the solid phase can readily be viewed through the liquid phase.

Other optional ingredients may also be included in conventional amounts in the liquid phase. Examples include enzymes, bleach activators (e.g. TAED) or bleach catalysts as further described hereinbelow, bleaches (such as PAP or percarbonate or any of the bleaching agents described further hereinbelow), silver-corrosion inhibiting agents, enzyme stabilizers, antifoam, soil release agents, dye transfer inhibiting agents, brighteners, perfumes, colorants and dyes. However incompatible ingredients will preferably not be included together in this phase. Such optional ingredients may be present in liquid form or may be present in solid form e.g. as speckles.

The liquid phase of the detergent composition may be produced by any suitable means. Suitable methods are already well known in the art e.g. mixing the ingredients together until a homogenous solution is obtained.

The shells 1, 2 are bonded to the tablet in regions 8, where the shells overlap the tablet. The bonding is preferably done using an adhesive, such as a hot-melt adhesive (e.g., PVOH, Sorbitol or PEG).

The tablet, shells and liquid are all manufactured separately. In order to assemble a capsule, a shell 1 is filled with a first liquid in an upright configuration. The tab 3 is then inserted into the top of the shell and the two components are adhered together. The tablet 3 with the shell 1 attached is inverted and inserted into the shell 2 to which it is bonded by the adhesive 8.

As can be seen in FIG. 2, a gap 9 is provided between the shells 1, 2 so that a part of the tablet 3 is exposed allowing gas to escape from the tablet to prevent swelling. Most of the outer wall of the capsule is, however, provided by the two shells allowing handling of the unwrapped capsule.

In an alternative construction, the shells 1, 2 may overlap with less of the tablet 3. Instead, a portion of the exposed tablet 3 may be coated with a barrier such as PVOH. This effectively achieves the same effect as the above described example in that it exposes enough of the tablet for gas to escape, yet still provides a capsule which can be handled without requiring an individual wrapper.

In use, the tablet may be placed directly into the washing cavity of a washing machine or dishwasher, or may be placed in the drawer or compartment specifically provided for the washing composition.

When exposed to the warm washing water, the table 3 and the shells 1, 2 begin to dissolve. Preferably, the tablet 3 is designed to dissolve before the shells 1, 2 so that the liquid in the cavities 4, 5 is only released once a substantial portion of the solid tablet 3 has dissolved.

As soon as the chambers 4, 5 are breached, the liquid is dispensed very rapidly which is advantageous in providing a high concentration of the composition in a short space time.

1. A washing capsule comprising:
a solid tablet of a first washing compositions;
at least a first rigid water-soluble shell fixed directly to the solid tablet to define a cavity between the shell and the tablet; and
a second washing composition contained within the cavity.

2. The capsule according to claim 1, wherein the second washing composition is in direct contact with the first washing composition.

3. The capsule according to claim 1, wherein the part of the solid tablet which faces the cavity is coated with a water-soluble barrier.

4. The capsule according to claim 3, wherein the water-soluble barrier is less than 0.2 mm thick.

5. The capsule according to claim 1 further comprising a second rigid water-soluble shell fixed directly to the solid tablet to define a second cavity between the second shell and the tablet, the second cavity containing a washing composition comprising one of the second washing composition or a third washing composition.

6. The capsule according to claim 5, wherein the first and second water-soluble shells have one or both of different thicknesses and different compositions.

7. The capsule according to claim 5, wherein the first and second water-soluble shells are respectively fixed on opposite sides of the solid tablet.

8. The capsule according to claim 1, wherein a portion of the solid tablet is exposed to the external environment.

9. The capsule according to claim 5, wherein a gap is provided between the first and second water-soluble shells to expose a portion of the tablet to the external environment.

10. A method of manufacturing a washing capsule comprising:
filling a first water-soluble shell with an amount of liquid or gel;
inserting a solid tablet of a first washing composition into the first shells; and
fixing the first shell to a portion of the tablet in order to form a closed first cavity between the first shell and the tablets;
wherein the liquid or gel contained within the first cavity is of a second washing composition.

11. The method according to claim 10 further comprising:
filling a second water-soluble shell with an amount of liquid or gel; and
fixing the second shell to a different portion of the tablet to form a closed second cavity between the second shell and the tablet.

12. The method according to claim 11, wherein:
the washing composition contained within the second cavity comprises one of the second washing composition or a third washing composition; and
fixing the shells to the tablet is done using an adhesive.

13. The method according to claim 12, wherein the adhesive is a hot-melt adhesive.

14. A washing capsule comprising:
a tablet of a first washing composition, the tablet having an outer surface;
a first water-soluble shell extending from a portion of the tablet, the first water-soluble shell having an inner surface, wherein a first cavity is formed and defined by at least a portion of the inner surface of the first water-soluble shell and a portion of the outer surface of the tablet; and
a washing composition contained within the first cavity.

15. The capsule of claim 14, wherein:
the first washing composition comprises a solid washing composition;
the washing composition contained within the first cavity is different from the first washing composition, the washing composition contained within the first cavity comprising a second washing composition; and
wherein the second washing composition is in direct contact with the first washing composition.

16. The capsule of claim 14, wherein:
the first washing composition comprises a solid washing composition;
the washing composition contained within the first cavity is different from the first washing composition, the washing composition contained within the first cavity comprising a second washing composition; and
at least a portion of the outer surface of the tablet that faces the first cavity is coated with a 0.1 mm thick water-soluble barrier.

17. The capsule of claim 14 further comprising:
a second water-soluble shell extending from a portion of the tablet, the second water-soluble shell having an inner surface, wherein a second cavity is formed and defined by at least a portion of the inner surface of the second water-soluble shell and a portion of the outer surface of the tablet; and
a washing composition contained within the second cavity; and
wherein at least a portion of the outer surface of the tablet does not form part of either the first or the second cavities.

18. The capsule of claim 17, wherein:
the first washing composition comprises a solid washing composition;
the washing composition contained within the first cavity is different from the first washing composition, the washing composition contained within the first cavity comprising a non-solid second washing composition;
the washing composition contained within the second cavity is different from the first washing composition, the washing composition contained within the second cavity comprising a non-solid third washing composition; and
the at least a portion of the outer surface of the tablet that does not form part of either the first or the second cavities being exposed to the external environment.

19. The capsule of claim 18, wherein:
the second and third washing compositions are different, and each selected from the group consisting of a liquid and a gel; and
the first and second water-soluble shells having one or both of different thicknesses and different compositions.

20. The capsule of claim 18, wherein:
the first and second water-soluble shells are respectively fixed on opposite sides of the tablet; and
wherein at least a portion of the outer surface of the tablet that does not form part of either the first or the second cavities comprises a gap of between 6 mm and 10 mm between the first and second water-soluble shells.
